(19) United States
(12) Patent Application Publication
(10) Pub. No.: US 2017/0069015 A1
(43) Pub. Date: Mar. 9, 2017

(54) METHODS AND SYSTEMS FOR ASSESSING ORDER COMPLIANCE BY DETERMINING PRE-SUBMISSION ORDER ADHERENCE OF A PRELIMINARY ORDER USING A FRONT-END SERVER

(71) Applicant: Georgia-Pacific Consumer Products LP, Atlanta, GA (US)

(72) Inventor: William Andrew Mosteller, Smyrna, GA (US)

(21) Appl. No.: 14/848,564

(22) Filed: Sep. 9, 2015

(51) Int. Cl. G06Q 30/06; H04L 29/06

(52) U.S. Cl. CPC G06Q 30/0637; H04L 67/42; G06Q 30/0609

(57) ABSTRACT

A front-end server based networked system is described that provides determines pre-submission order adherence of a preliminary order of program goods. When an authorized user connects with the front-end server and is selectively presented with order program goods that maybe selected for the preliminary order, the system generally receives the preliminary order information, accesses relevant order program limitations for the authorized user and a shipment compliance limitation, and determines the pre-submission order adherence of the preliminary order by comparing the received preliminary order information to a combination of the relevant order program limitations and the shipment compliance limitation. The front-end server then generates a notification providing order compliance feedback to a client device operated by the authorized user to provide the results of determining the pre-submission order adherence of the preliminary order, and can transmit a formatted order corresponding to the compliant preliminary order information.

### FIELD OF THE DISCLOSURE

The present disclosure generally relates to improvements and enhancements in the field of electronic sales order processing and, more particularly, to improvements and enhancements involving systems, apparatus and methods that assess order compliance of a preliminary or proposed order using a front-end server to determine pre-submission order adherence.

### BACKGROUND

In the past, a supplier or product provider (generally referred to herein as a seller) may have created a hard copy catalog of items for sale and sent such catalogs to a wide spectrum of potential buyers. Buyers may then have viewed potential goods or services being offered by the seller in the catalog, and then personally followed up with the seller to place an order.

A supplier or product provider may host an electronic order processing and management system with which the provider may offer goods or services for sale to buyers via electronic interactions between buyer systems and seller systems (e.g., Electronic Data Interchange (EDI) methods for communicating purchase orders, invoices, shipping notices, and other business documents in a standardized format for such documents). Conventional electronic order processing and management systems are known to be complicated and integral systems at the heart of a seller's business given such systems are usually burdened with a large number of responsibilities involved with receiving orders, processing the orders, and coordinating fulfillment of the orders. In more detail, a conventional electronic order processing and management system for a business may be deployed within a business enterprise and used for receiving orders, matching orders with relevant inventory, inventory management from internal stores and outside procurement, payment and billing for the order, and order fulfillment tasks such as coordinating product pulls from inventory, packaging, shipment loading, and delivery to the purchasing customer. Thus, conventional electronic order processing and management systems are known to be burdened and challenged given the vast number of order-related tasks that follow order submission.

To help address such challenges, it is generally known to pre-process an electronic commerce request before the request is sent to an order processing system. For example, U.S. Pat. No. 7,606,742 describes how a particular type of pre-processing of electronic commerce request may involve performing a product availability check before the electronic commerce request (such as a sales order) is posted to an order processing or management system. The '742 prior art patent describes reviewing a submitted EDI order for errors (e.g., incomplete fields or ordering of non-existing products) and using particular business rules based on determined product availability from inventory (e.g., satisfaction determinations for specific dates and quantities based on identified availability from inventory and product substitutions based on identified availability of such corresponding substitute products from inventory). However, such known examples of pre-processing an electronic commerce request rely on knowing an up-to-date status of inventory, which also burdens the relevant electronic order processing and management systems, as well as lacks consideration of how to automatically manage what is being ordered and shipped with respect to compliance limitations, lacks consideration of load efficiency at a very early point in the electronic order processing cycle, and does not consider whether it adheres to standards for the seller.

To help address these types of problem with burdened order management systems and optimizing how an order may be “built” electronically, an improved way to assess order compliance via an enhanced interface with a buyer is needed prior to submission to the order management system. Thus, there remains a need for improved methods and systems for assessing order compliance by determining pre-submission order adherence of a preliminary order of select program goods.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

One aspect of the disclosure relates to an improved method for assessing order compliance by determining pre-submission order adherence of a preliminary order of program goods using a front-end server coupled to an order management apparatus in a networked system. In this aspect, the improved method generally begins with the front-end server generating a portal interface for a client device in communication with the front-end server and then receiving secure login information from the client device, where the secure login information identifies an authorized user. The method proceeds with the front-end server accessing order program limitations (such as limitations associated with the authorized user and related to combined order volume and order weight) maintained in a memory of the front-end server based upon at least a portion of the secure login information identifying the authorized user. The front-end server then generates a selective entry interface portion on the portal interface for information on the preliminary order, where the selective entry interface portion is populated with program goods consistent with the order program limitations associated with the authorized user. After receiving the information on the preliminary order from the client device via the selective entry interface portion, the method continues with the front-end server comparing the received information on the preliminary order to the order program limitations associated with the authorized user and to a shipment compliance limitation maintained in the memory of the front-end server as part of determining the pre-submission order adherence of the preliminary order. In response to this comparison that has the effect of improvement management of shipping of items to be ordered, the method has the front-end server providing order compliance feedback to the client device over the portal interface. Such order compliance feedback provides the results of determining the pre-submission order adherence of the preliminary order, and has the further effect of arming the client with pre-submission compliant order for the program goods in an electronic format suitable for error-reduced submission to an order management system.

Another aspect of the disclosure describes a pre-submission order adherence system for a preliminary order of program goods. In this aspect, the system generally includes a group of different computer systems (i.e., a front-end server, an order management system, and a customer service server) that interact in an unconventional manner that has the effect of enhancing order processing functionality. The front-end server further comprises at least a network communication interface and a memory storage. The network communication interface provides access to a separate customer client device over a data communication network while the memory storage in the front-end server maintains an order compliance program module. Such an order compliance program module deployed in and executed by the front-end server of the system comprises at least a portal logic portion operative to generate a portal interface for the customer client device over the network communication interface, and an order adherence logic portion operative to selectively provide user specific order program limitations and a shipment compliance limitation. Separate from the front-end server, the order management system is a processing-based system that is deployed as part of the pre-submission order adherence system in communication with the front-end server over the network communication interface of the front-end server. The order management system, as part of this pre-submission order adherence system, is operative to accept an order for the program goods and manage fulfillment operations related to the order. The customer service server is deployed in communication with the front-end server over the network communication interface of the front-end server. The customer service server, as the remaining part of this pre-submission order adherence system, is operative to communicate with the order management system.

In more detail, these three components of the pre-submission order adherence system interact and unconventionally operate together as part of the system. For example, the front-end server, when executing the order compliance program module, is operative to generate, using the portal logic portion, the portal interface in response to a request from the customer client device; receive secure login information from the customer client device, where the secure login information identifies a registered user; use the order adherence logic to identify the user specific order program limitations and the shipment compliance limitation based upon the identified registered user; generate a prompt via the portal interface, where the prompt requests information on the preliminary order; receive the information on the preliminary order in response to the prompt; determine the pre-submission order adherence of the preliminary order by comparing the received information on the preliminary order to the identified user specific order program limitations and to the shipment compliance limitation; generate order compliance feedback for display within a portion of the portal interface, where such order compliance feedback provides the results of determining the pre-submission order adherence of the preliminary order; and transmit an order summary message to at least one of the customer client device and the customer service server when (a) the order compliance feedback indicates a compliance state for the preliminary order and (b) in response to receiving an order submission input from the customer client device over the portal interface. The order summary message comprises a formatted order associated with the preliminary order in a format suitable for submission to the order management apparatus. Additionally, the customer service server is further operative to receive the order summary message notifying the customer service server about the compliance state for the preliminary order, and then provide the formatted order to the order management system as the order for the program goods, which has the technical effect of removing the order-compliance burden for the order management system with pre-submission order adherence operations performed by another part of the overall system.

In a further aspect of the disclosure, another improved method is described for assessing order compliance by determining pre-submission order adherence of a preliminary order of program goods using a front-end server coupled to an order management apparatus in a networked system. In this additional aspect, the improved method generally begins with the front-end server executing a portal interface code module to generate a portal interface for a client device in communication with the front-end server. The front-end server then receives, when executing the portal interface code, secure login information from the client device via the portal interface, the secure login information identifying an authorized user. The method proceeds with the front-end server executing an order adherence code module to access a subset of order program limitations maintained on a memory storage of the front-end server. Such a subset of order program limitations includes those associated with the identified authorized user (whether all order program limitations maintained on the memory storage or whether less than all of the order program limitations kept on the memory storage). Specifically, the subset the subset of order program limitations includes at least a set of authorized program goods for selection by the identified authorized user, and a combination of an order volume restriction and an order weight restriction.

The method continues with the front-end server generating a selection entry interface portion within the portal interface when executing the portal interface code. The selection entry interface portion comprises a plurality of entries corresponding to the set of authorized program goods. Upon receiving an initial selection from the client device of one or more of the entries from the selection entry interface portion of the portal interface (where the initial selection corresponds to received information on the preliminary order), the front-end server, when executing the order adherence code, compares the received information on the preliminary order to the subset of order program limitations associated with the identified user and to a shipment compliance limitation as part of determining the pre-submission order adherence of the preliminary order. The method proceeds to have the front-end server, when executing the portal interface code, generating a compliance notification portion within the portal interface. Such a compliance notification portion provides at least initial order compliance feedback (e.g., the results of determining the pre-submission order adherence of the preliminary order) to the client device.

Next, the method proceeds to have the front-end server, when executing the portal interface code, updating the compliance notification portion within the portal interface to provide updated order compliance feedback to the client device as revised results of determining the pre-submission order adherence of the preliminary order as the front-end server receives an updated selection from the client device of one or more of the entries from the selection entry interface portion. The updated selection reflects a current state of the received information on the preliminary order, and revises the determination of the pre-submission order adherence of the preliminary order based on an updated comparison of the current state of the received information on the preliminary order to the subset of order program limitations and to the shipment compliance limitation. Finally, the method has the front-end server, when executing the order adherence code, generating a formatted order from the information on the preliminary order when the updated order compliance feedback indicates a compliance state for the preliminary order, which has the technical effect of ensuring the preliminary order is in a format acceptable to the order management system and allowing the order management system to process orders that do not waste the operational cycles of that system when processing such orders.

Each of these aspects respectively effect improvements to the technology of electronic procurement and order processing, improve the operation of systems that process orders, and address the technical issue of overburdened processing systems and under-utilized shipping platforms that results in an electronically formatted and adherent order that improves the operation of the order processing system. Additional advantages of this and other aspects of the disclosed embodiments and examples will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments according to one or more principles of the invention and together with the description, serve to explain one or more principles of the invention. In the drawings,

FIG. 1 is a diagram illustrating a networked system for determining pre-submission order adherence for a preliminary order of program goods in accordance with an embodiment of the invention;

FIG. 2 is a block diagram of an exemplary front-end server used in the networked system of FIG. 1 in accordance with an embodiment of the invention;

FIG. 3 is a block diagram of exemplary software modules and data structures used as part of the exemplary front-end server of FIG. 2 in accordance with an embodiment of the invention;

FIGS. 4A-4F are a series of exemplary user interface screens shown on a customer client device when interacting with the exemplary front-end server of FIG. 2 in accordance with an embodiment of the invention;

FIG. 5 is a flow diagram illustrating exemplary steps for an improved method for assessing order compliance by determining pre-submission order adherence of a preliminary order of program goods using a front-end server coupled to an order management apparatus in a networked system in accordance with an embodiment of the invention; and

FIGS. 6A and 6B are collectively another flow diagram illustrating exemplary steps of an improved method for assessing order compliance by determining pre-submission order adherence of a preliminary order of select program goods using a front-end server coupled to an order management apparatus in a networked system in accordance with an embodiment of the invention.

### DESCRIPTION OF THE EMBODIMENTS

Reference will now be made in detail to various exemplary embodiments. Wherever possible, the same reference numbers are used in the drawings and the description to refer to the same or like parts, code, data, or other structure.

In general, the various embodiments described below focus on a front-end server processing platform that operates in an improved way to efficiently assess order compliance by determining pre-submission order adherence of a preliminary order of select program goods. Basically, an exemplary front-end server may determine pre-submission order adherence that involves compliance with thresholds related to a combination of order volume (such as the number of items and/or physical space taken by the ordered items), weight, and shipment load characteristics (e.g., order meeting a desired percentage capacity thresholds for a single shipment) for a proposed or preliminary order prior to submitting the order to a separate order management system. With such a server that may interact with client devices and the order management system, determining pre-submission order adherence may involve order program limitations related to a particular registered or authorized customer as well as shipment compliance limitations. The ability to quickly, automatically, and interactively present order compliance feedback to the customer via a specialized buying user interface allows for an order grooming tool and type of process that has the advantageous technical effect of offloading the order processing burden from the order management system while automatically driving load efficiency to further offload the order management system with fulfillment processing tasks, which also has the effect of reducing the seller's cost to service the customer's ultimate order of such goods.

Those skilled in the art will appreciate that each embodiment described herein effects improvements to particular technologies, such as electronic procurement systems or order processing systems. Each embodiment describes a specific technological application of an improved way to determine pre-submission order adherence and order compliance where the specific technological application improves or otherwise enhances the operation of an enterprises' order processing system (including the order management system) as explained and supported by the disclosure that follows.

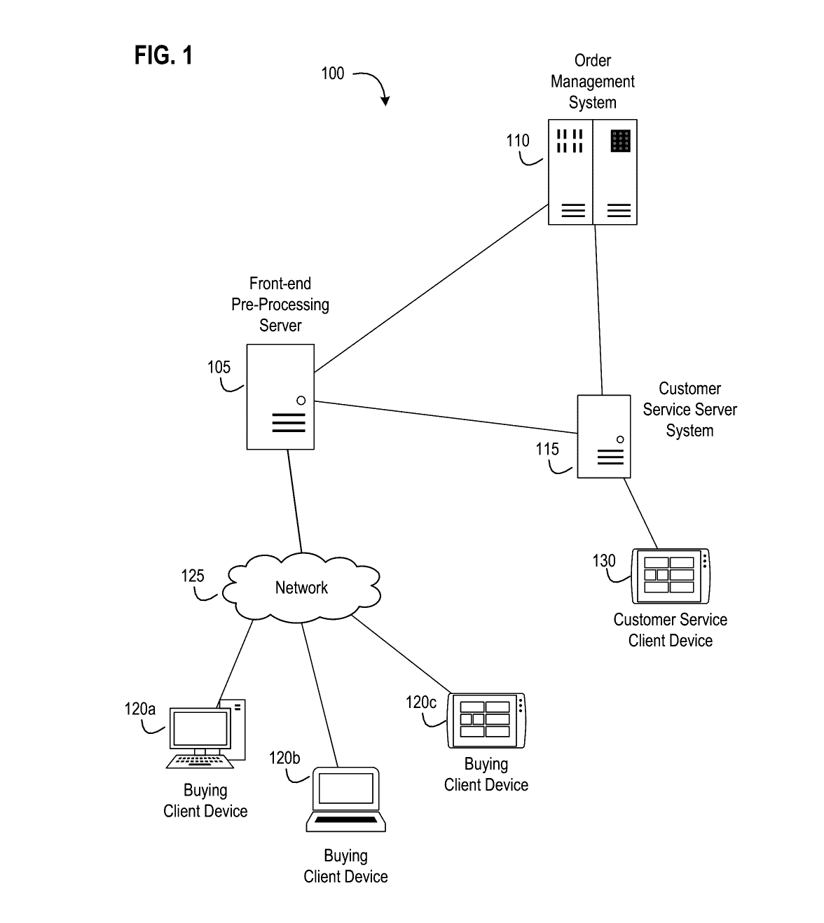

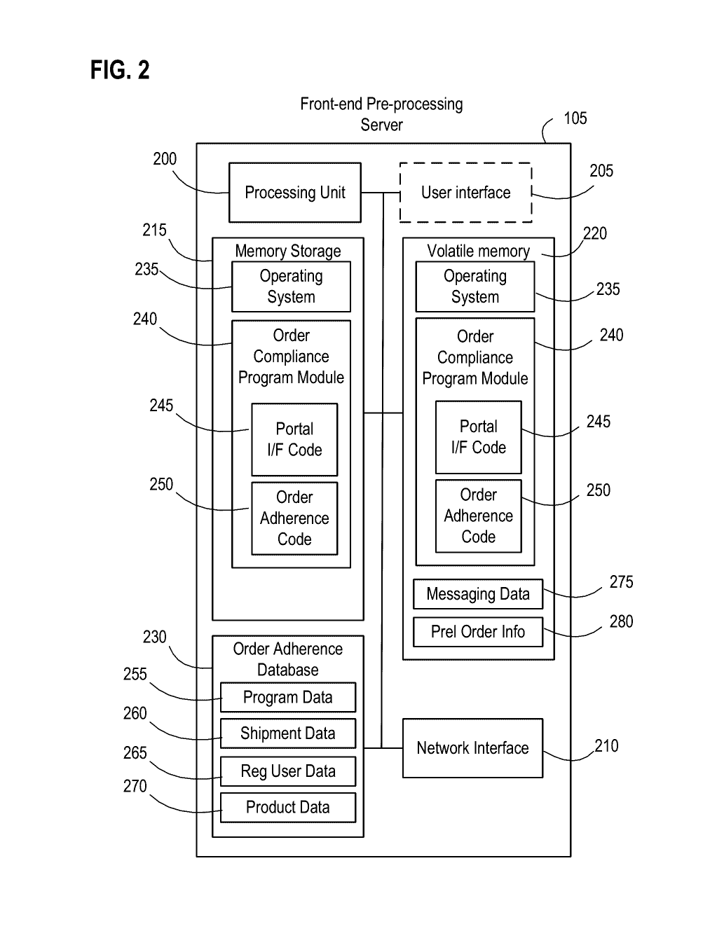

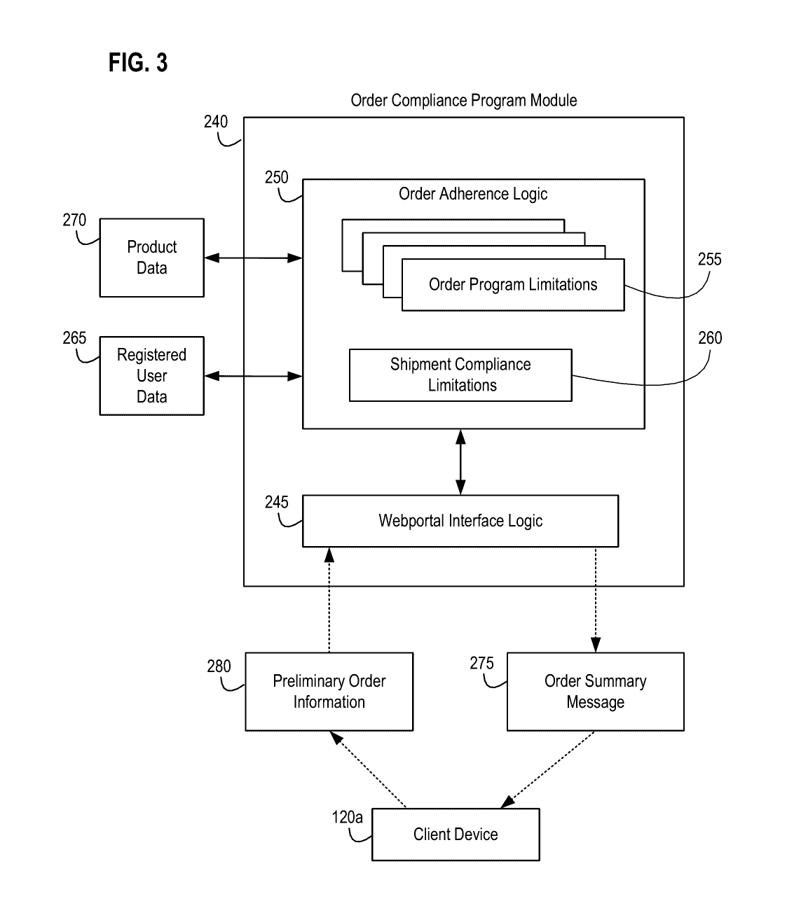

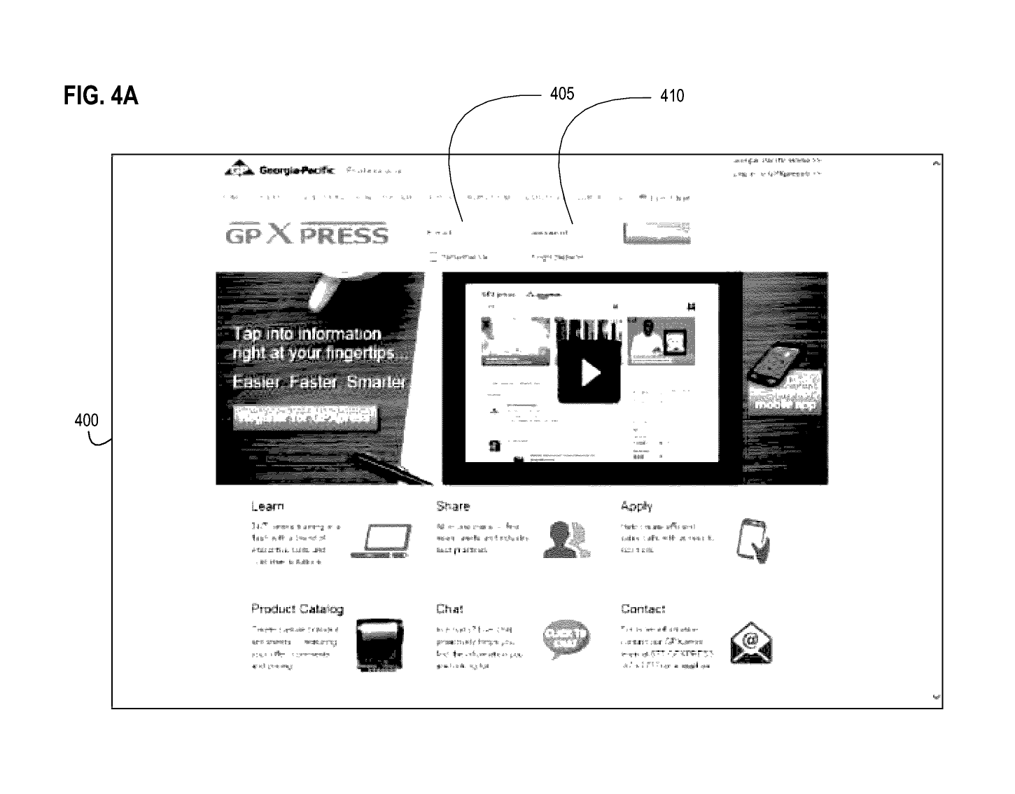

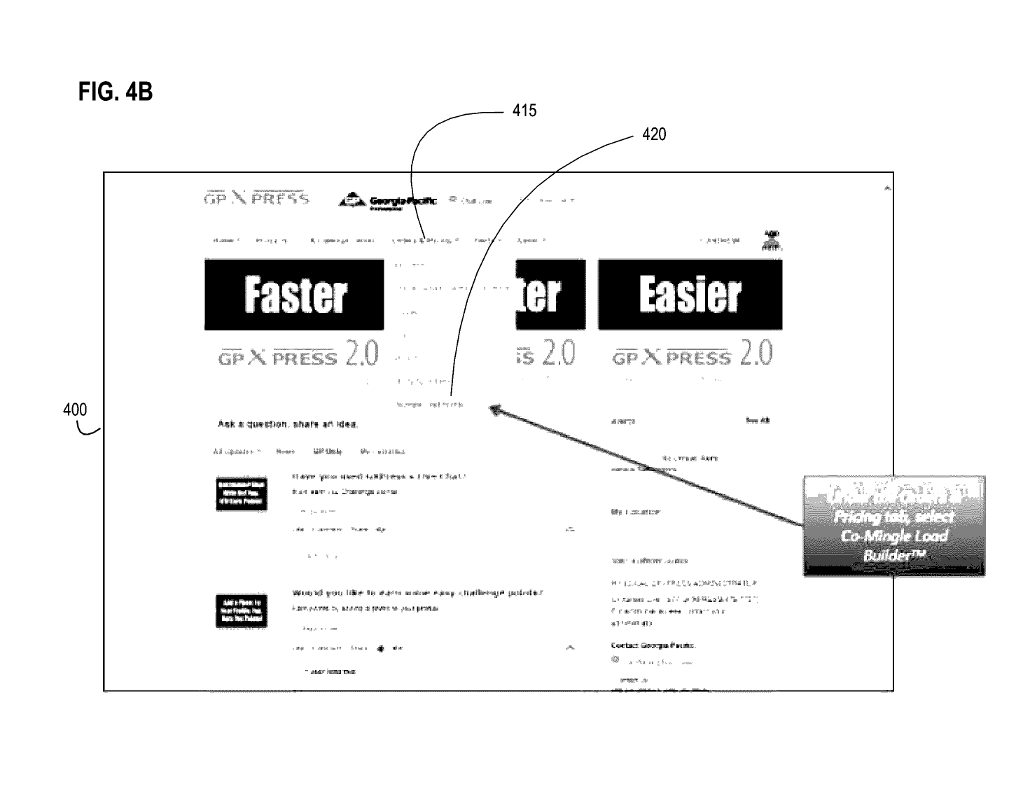

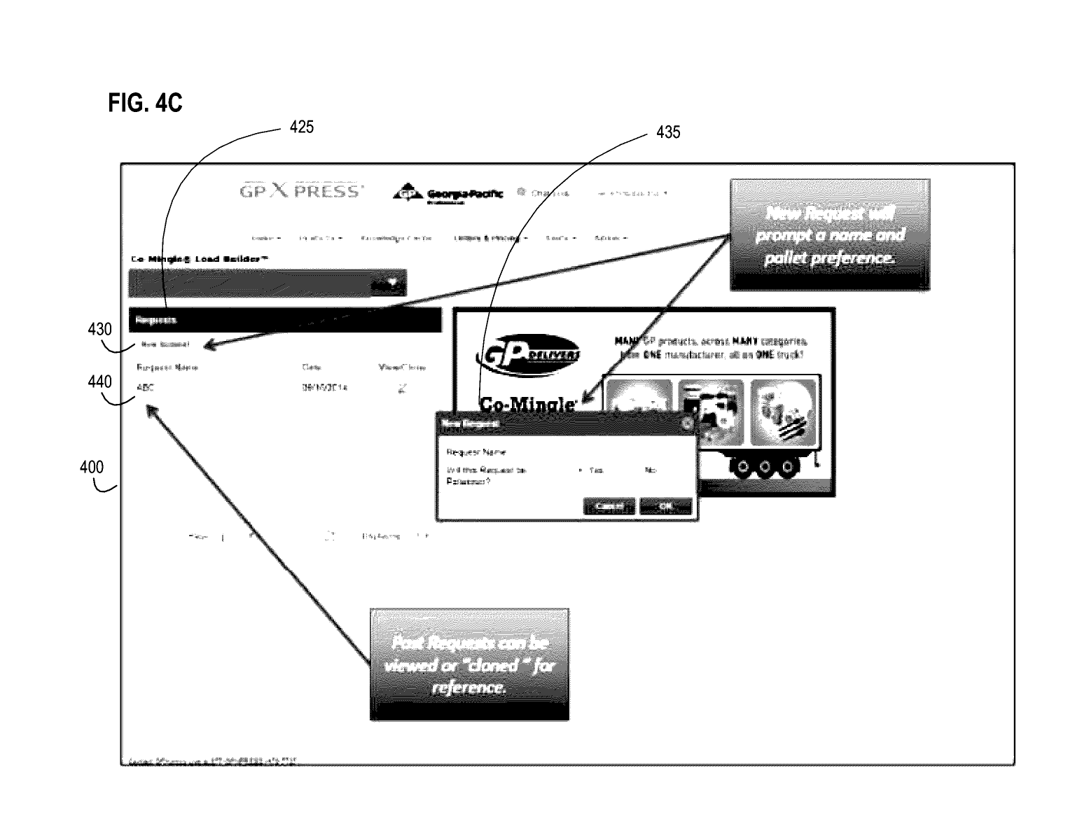

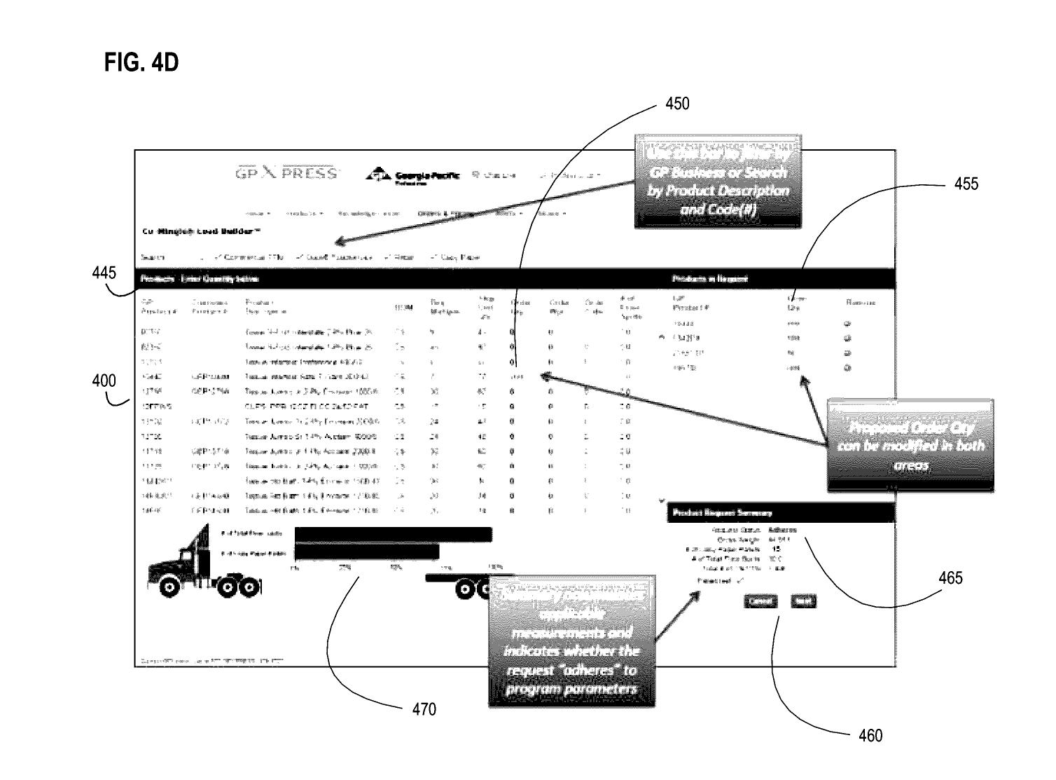

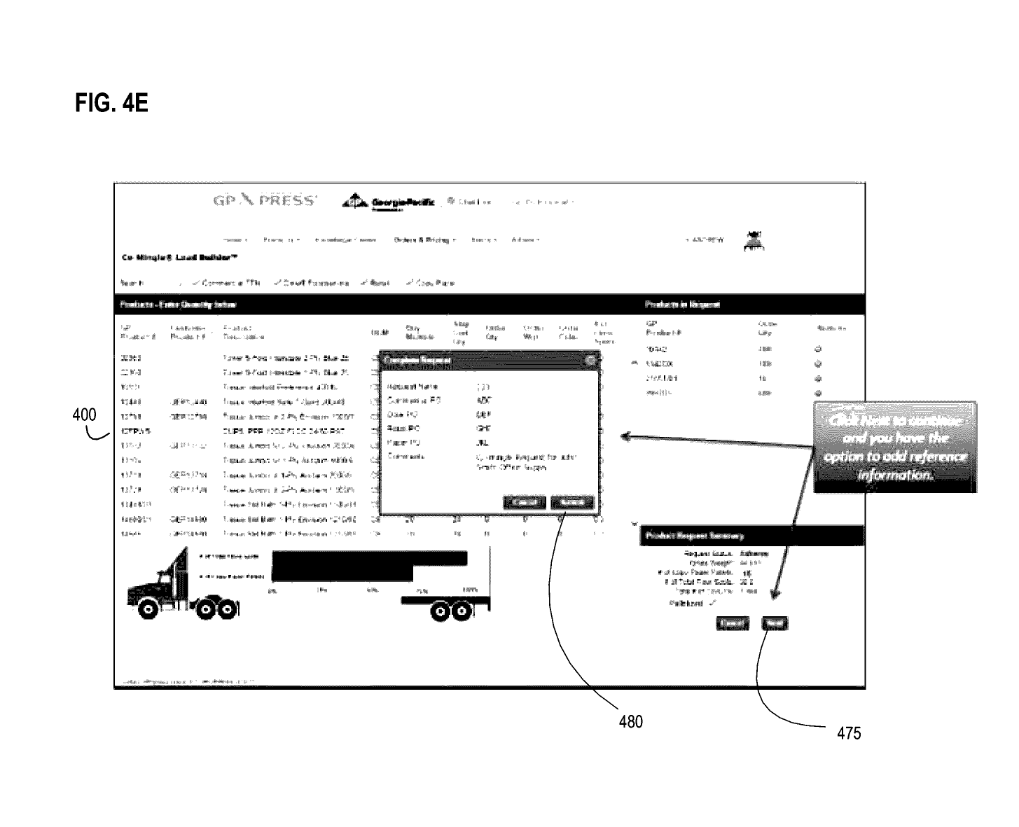

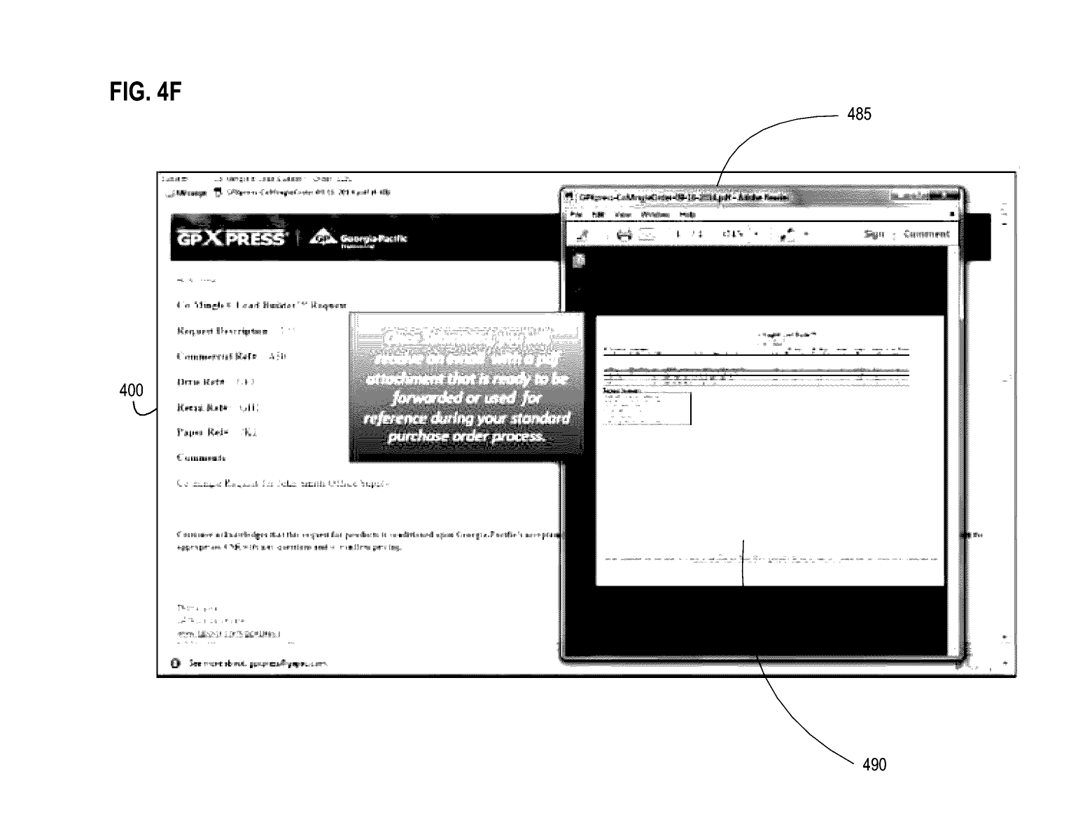

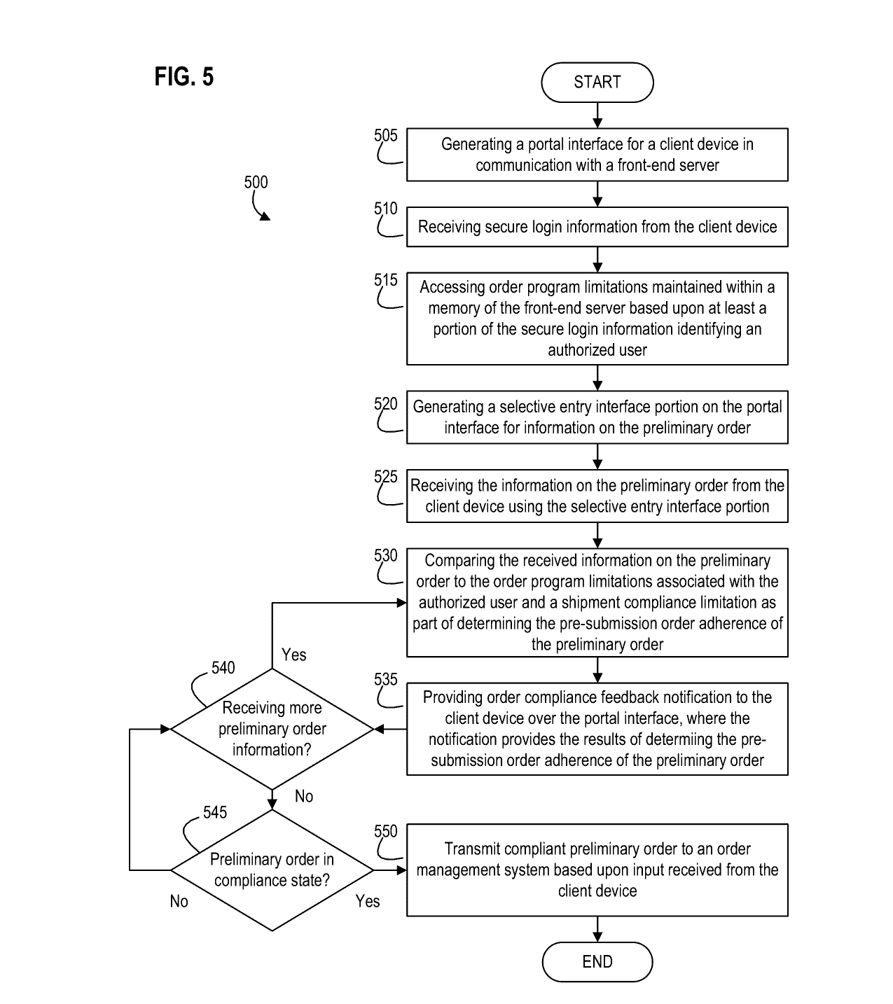

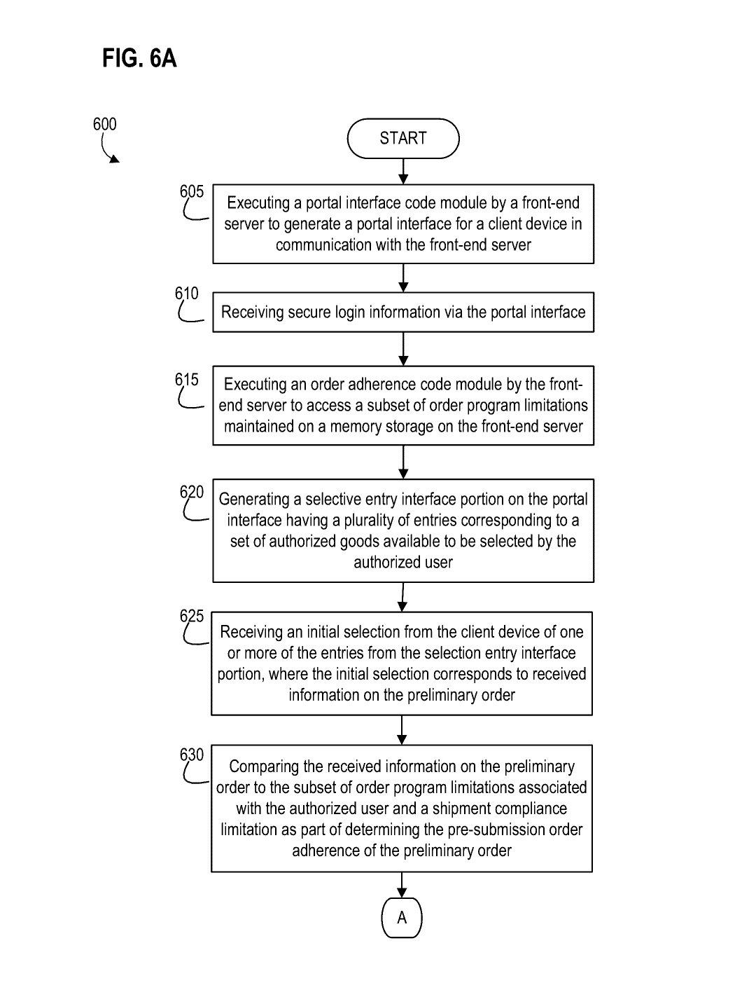

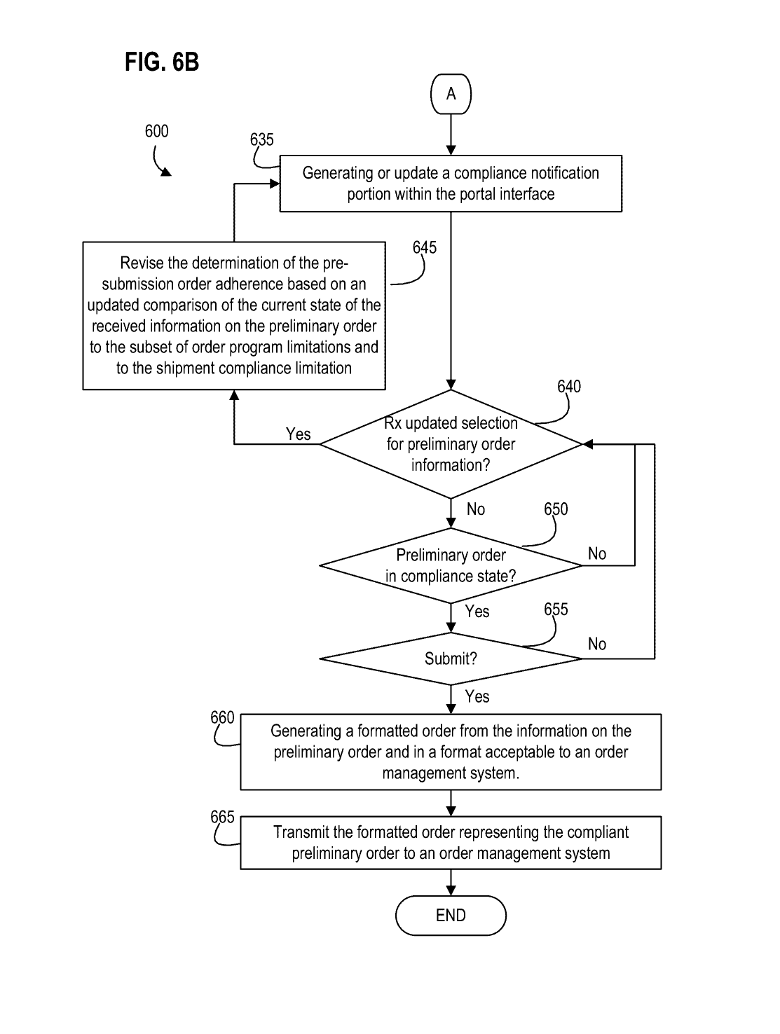

In general, FIG. 1 is a high level schematic diagram showing a networked system of different processing elements involved in assessing order compliance by determining pre-submission order adherence of a preliminary order of program goods. FIG. 2 provides further details of the front-end server shown in FIG. 1 while FIG. 3 provides insight on software module and data interactions as the front-end server interacts with different ones of the processing systems. FIGS. 4A-4F provide more of a user interface view of how a buying client may enter preliminary order information and use the deployed system to determine pre-submission order adherence with order compliance feedback. FIGS. 5, 6A and 6B provide exemplary flow diagrams illustrating algorithmic steps involved in operations of such an exemplary system.

Referring now to FIG. 1, a networked system 100 for determining pre-submission order adherence for a preliminary order of program goods is illustrated as an example operating environment for one or more embodiments of the invention. In more detail, the networked system 100 shown in FIG. 1 includes, at its core, a front-end pre-processing server 105. Exemplary front-end pre-processing server 105, as explained in more detail below with respect to FIG. 2, is generally server that operates as a specialized a web server. Front-end server 105 is operative to pre-process preliminary order information provided by one or more buying client devices 120a-c and determine order adherence in an advantageous and novel manner that helps have the technical effect of offloading the processing burden on order management system 110 and results in providing a pre-processed electronically formatted order suitable for submission that is already compliant and efficiently manages shipping related costs for the order.

The front-end pre-processing server 105, in some embodiments, may have a direct data communication connection to order management system 100 where, for example, EDI information may be exchanged when directly submitting a compliant preliminary order from front-end server 105. In one embodiment, order management system 100 may be implemented as a type of dedicated enterprise-wide networked computing platform capable of connecting to and interacting with at least front-end pre-processing server 105 as part of a system that conducts order adherence determinations that enhance the overall order processing and management of the system. In general, those skilled in the art will appreciate that such an exemplary order management system 100 is a hardware-based component that may run order management software (such an Enterprise Resource Planning software from SAP) and may be implemented in a wide variety of ways depending on the scope of demands placed upon the system 100 when handling, processing, and managing orders. For example, system 100 may be implemented as a single computing system, a distributed server (e.g., separate servers for separate server related tasks), a hierarchical server (e.g., a server implemented with multiple levels where information may be maintained at different levels and tasks performed at different levels depending on implementation), a server farm that logically allows multiple distinct components to function as one server computing platform device or system from the perspective of outside computing devices (e.g., front-end pre-processing server 105), or a cloud-based server with remote systems running order management software solutions as a massively parallel software-as-a-service (SaaS) solution for managing enterprise business operations with orders, inventory, and shipment. In some regional deployments, an exemplary server may include servers dedicated for specific geographic regions as information collected within different regions may include and be subject to different regulatory controls and requirements implemented on respective regional servers.

The front-end pre-processing server 105 is also shown in FIG. 1 with a data communication connection to customer service server system 115, a type of server (as explained above with respect to system 110). Customer service server system 115 may, in some embodiments, include a local user interface (e.g., terminal) for use by customer service personnel. However, in other embodiments, customer service server system 115 may be in communications with a customer service client device 130 (such as a tablet, smartphone, a laptop computer, or a desktop computer operated by customer service personnel). The data communication connection from front-end server 105 to customer service server system 115 may be via a wired or wireless data communications path (such as a wide area network (WAN) connection, a local area network (LAN) connection, a Wi-Fi connection, a cellular connection, and the like) or a combined wired/wireless data communications path. Front-end server 105 may, in some embodiments, provide messages (such as an order summary message) to customer service server system 115 or customer service client device 130 once a preliminary order has been found to be compliant with particular program order and shipment limitations and the compliant preliminary order is to submitted to the order management system 110 indirectly through customer service server system 115 (which may allow customer service personnel operating customer service client device 130 to access and review the compliant preliminary order as part of submitting the compliant preliminary order to order management system 110).

Additionally, aside from the systems that may later handle/process compliant preliminary order information, the front-end pre-processing server 105 is coupled through network 125 to various buying client devices 120a-120c (such as a tablet, smartphone, a laptop computer, or a desktop computer). Network 125 that provides a data communication path between front-end server 105 and buying client devices 120a-120c may be implemented as a data communication network involving a variety of communication networks or paths. Such exemplary networks or paths may be implemented with hard wired structures (e.g., LAN, WAN, telecommunication lines, telecommunication support structures and telecommunication processing equipment, etc.), wireless structures (e.g., antennas, receivers, modems, routers, access points, repeaters, etc.) and/or a combination of both depending upon the desired implementation of a network that interconnects front-end server 105 and the buying client devices 120a-120c. For example, those skilled in the art will appreciate that network 125 may be a private secure network, a virtual private network (VPN) extending over a publicly accessible network via secure tunneling protocols, or a public data network (such as the Internet). Further embodiments of networked system 100 may deploy network 125 as a single path or diverse multipath data communication connection between one or all components shown in FIG. 1 in an embodiment of the present invention.

Generally, buying client devices 120a-120c allow a user to interact with front-end pre-processing server 105. The user of a buying client device in an embodiment may be an online customer, such as a retail customer, a distributor for the seller's goods, or a distributor's customer that desires to purchase the seller's goods via the distributor). As noted above, buying client devices 120a-120c, may be implemented using a desktop computer, a laptop computer, a tablet (such as an Apple iPad® touchscreen tablet), a personal area network device (such as a Bluetooth® device), a smartphone (such as an Apple iPhone®), a smart wearable device (such as a Samsung Galaxy Gear™, Pebble Time Steel™, or Apple Watch™ smartwatch device) or other such devices capable of communicating over network 125 with front-end server 105. Thus, an exemplary buying client device may be a mobile type of device intended to be easily moved (such as a tablet or smartphone), and may be a non-mobile type of computing device intended to be operated from a fixed location (such as a desktop computer). Consistent with above-mentioned examples of different types of buying client devices, those skilled in the art will appreciate that an exemplary buying client device, such as device 120a, may include sufficient hardware and code (e.g., an app or other executable program code section or sections) that allows the device to interactively provide information (such as login information and preliminary order information) to front-end server 105 and receive information back from front-end server 105 for display as part of a user interface shown on the buying client device. For example, the front-end server 105 may operate to generate a portal interface (such as an Internet browser window) running on the buying client device. As such, the front-end server 105 may operate to receive information and other user input through such a portal interface, and provide order compliance feedback to the buying client device with updated textual, symbolic, and/or graphic information to be shown within parts of the portal interface. A further example of such interfaces is explained through the example illustrated in FIGS. 4A-4F, which show various screenshots on an exemplary buying client device during operation and use of front-end pre-processing server 105.

FIG. 2 is a more detailed block diagram of exemplary front-end server 105 used in the networked system of FIG. 1 in accordance with an embodiment of the invention to determine pre-submission order adherence of a preliminary order of program goods. Like system 110 and customer service server system 115, front-end server 105 is a hardware-based component that may be implemented in a wide variety of ways. For example, server 105 may use a single processor or may be implemented as a multi-processor component that may operate a specially adapted pre-processing web server. Further, exemplary front-end server 105 may be implemented as a single computing system, a distributed server (e.g., separate servers for separate server related tasks), a hierarchical server (e.g., a server implemented with multiple levels where information may be maintained at different levels and tasks performed at different levels depending on implementation), or a server farm that logically allows multiple distinct components to function as one server computing platform device from the perspective of a client device (e.g., devices 120a-120c) or other server or system.

Referring now to FIG. 2, exemplary front-end server 105 in a basic form comprises a processing or logic unit 200 coupled to a network interface 210, which facilitates and enables operative connections and communications through network 125 with buying client devices 120a-c as well as, in some embodiments, with customer service system 115 and order management system 110 (whether through network 125 or other data communication paths to such systems). Using these communication paths as well as executable program code or program modules, the front-end server 105 generally provides a portal interface for the buying client devices 120a-120c as part of determining pre-submission order adherence for preliminary orders for program goods (e.g., particular goods and/or services offered by a seller associated with the order management system 110).

An embodiment of front-end server 105 may also provide a user interface 205 that allows local interaction (e.g., user input, server generated feedback or responsive information displayed) with server 105. In one embodiment, user interface 205 may provide a display, interactive buttons or soft keys, and a pointing device (e.g., a mouse) to facilitate interaction with the display. In a further embodiment, a data entry device (such as a keyboard) may also be used as part of the user interface 205. In other embodiments, user interface 205 may take the form of one or more lights (e.g., status lights), audible input and output devices (e.g., a microphone and speaker), or a touchscreen.

As a computing platform, the processing unit 200 of exemplary front-end server 105 is operatively coupled to non-volatile memory storage 215 and volatile memory 220, which collectively store and provide a variety of executable program code (e.g., operating system 235, order compliance program module 240, portal interface code 245, and order adherence code 250) as well as data generated or received during operations of front-end server 105 (e.g., messaging data 275 and preliminary order information 280). As explained in more detail below, an embodiment of order compliance program module 240 is generally an executable set of instructions that provides a type of specialized web server functionality and inter-system communications as part of assessing order compliance by determining pre-submission order adherence of a preliminary order of program goods.

The portal interface code 245 is generally a part of program module 240 that, through coordination with operating system 235 and network interface 210, generates a portal interface for a buying client device. Basically, the portal interface code 245 on front-end server 105 may be the server-side code for a client/server communication interface where code may exist on the client-side that enables the communication interface. For example, the portal interface code 245 may provide or serve up webpage code (as the server-side part) to a browser application (as the client-side part) running on a buying client device where the portal interface code 245 services webpage requests and other browser input from the buying client device as well as presents further information as new or updated interface content.

The order adherence code 250 (also referred to as order adherence logic) is another part of program module 240 that provides executable code for determining particular order program limitations and shipment compliance limitations that, in combination, are compared to preliminary order information supplied through portal interface code 245 when determining pre-submission order adherence of the supplied preliminary order information.

Those skilled in the art will appreciate that non-volatile memory storage 215 is a tangible, non-transient computer readable medium on which information data and executable code may be kept in a non-volatile and non-transitory manner. In addition to the memory storage media of non-volatile memory storage 215, exemplary front-end server 105 may also have a database 230 as another memory storage media operatively coupled to the processing unit 200. Such memory storage media may be in differing non-transitory forms accessible by front-end server 105 (e.g., read only memory (ROM), conventional hard disk drives, solid state memory such as flash memory, optical drives, RAID systems, cloud storage configured memory, network storage appliances, etc.). Those skilled in the art will appreciate that such memory storage media may be logically considered part of front-end server 105 even if in a different physical location than front-end server 105 (such as with cloud storage configured memory or external network storage appliances).

Database 230 (also referenced as order adherence database 230 shown in FIG. 2) may serve as accessible memory storage for types of data used when order compliance program module 240 and its related code sections (e.g., portal interface code 245 and order adherence code 250) are being executed in volatile memory 220. Such data may include, for example, program data 255, shipment data 260, authorized user data 265, and product data 270.

In one embodiment, program data 255 is a type of data that defines particular purchasing program order restrictions relating to what type of items may be purchased, quantity of items, physical space taken by ordered items, weight of ordered items, and thresholds relating to such parameters. Such program parameters represented by the program data 255 may be combined to limit or restrict what is considered to be compliant in accordance with a purchasing or order program setup between the seller and buyer. As such, the program data 255 on database 230 may be periodically updated as more buyers register to use the front-end server 105 or existing authorized buyers may have new thresholds or new types of products available for purchase given an updated order program with the existing authorized buyer.

Those skilled in the art will appreciate that in some embodiments, the program data 255 may define a subset of a seller's potential goods/items for sale. For example, a particular buyer may be limited as to what they can purchase online via their respective purchasing or order program with the seller. However, in other embodiments the program data 255 may be less restrictive and set forth how the program parameters represented by the program data 255 for a particular buyer allows the buyer to purchase all manner of goods sold online by the seller.

Further, other embodiments of program data 255 may be more restrictive in some aspects while less restrictive in other aspects. For example, the program data 255 for a particular buyer may represent program parameters where the buyer is allowed to purchase all manner of goods sold online by the seller, but still have some restrictions related to weight of ordered items. As such, exemplary program data 255 may allow the buyer to purchase a particular item in a quantity of 2 but not allow the online purchase of 10,000 of the same item.

Shipment data 260 is also a type of data that defines another kind of ordering limitation. More specifically, shipment data 260 defines one or more shipment compliance limitations, such as a shipment load compliance characteristic associated with a transport container. For example, such a shipment load compliance characteristic may be a desired percentage occupied threshold for a transport container to be used for shipping the preliminary order of goods.

The authorized user data 265 maintained in database 230 is registration information that may be used to confirm a user attempting to log into front-end server 105 via the portal interface is authorized to do so. For example, new buyers may go through an online registration session where new registration information (e.g., user ID, password, etc.) is created and stored as part of authorized user data 265, and then used when the buyer attempts to login with the front-end server 105 and provide the preliminary order so that server 105 can determine pre-submission order adherence for the preliminary order.

The product data 270 maintained in database 230 is information related to the program goods sold by the seller. Such product data 270 may be updated to reflect new products or to reflect that the seller no longer offers other products for sale.

Upon power up of front-end pre-processing server 105, volatile memory 220 may be populated first with operating system 235 to provide basic computer functionality and drivers that allow the operating system 235 and other operational program modules (such as order compliance program module 240) to interact with hardware components of server 105 (such as database 230, network interface 210, memory storage 215, and the like. And during operation of front-end server 105, as the operational program modules (e.g., order compliance program module 240) are loaded into volatile memory 220 and executed, volatile memory 220 may also include certain data (e.g., messaging data 275 and preliminary order information 280) generated as the front-end server 105 executes code from the program modules.

Those skilled in the art will appreciate that not all data elements illustrated in FIG. 2 must appear in non-volatile memory storage 215, volatile memory 220, and database 230 at the same time. Likewise, other embodiments may include the data maintained within database 230 directly within non-volatile memory storage 215 or rely on separate devices accessible through network interface 210 to maintain such data, information, or code.

FIG. 3 is a high-level block diagram that helps explain how such exemplary software modules and data structures used as part of the exemplary front-end server 105 of FIGS. 1 and 2 may interact with each other when assessing order compliance by determining pre-submission order adherence of a preliminary order of program goods. Referring now to FIGS. 1 and 3, an exemplary buying client device (such as one of client devices 120a-120c) is shown as communicating with order compliance program module 240 through portal interface logic 245. To begin a preliminary order session, portal interface logic 245 presents buying client device 120a with an interface that allows a user operating buying client device 120a to enter secure login information, such as a user identification and a password. Such secure login information may be checked by order compliance program module 240 against registered user data 265 to confirm the user is registered and authorized to submit preliminary order information and make further use of front-end server 105.

Once the user is identified to be an authorized user, the user may interact with buying client device 120a to providing preliminary order information 280 to front-end server 105 via the portal interface logic 245. The portal interface logic 245 may present a prompt for display on the interface shown on the buying client device 120a that displays what type of items may be purchased according to order program limitations 255 for the authorized user and the product data 270 accessible to order adherence logic 250. Once received, the preliminary order information 280 is essentially passed through portal interface logic 245 to order adherence logic 250 of the order compliance program module 240. At this point, the order adherence logic applies the appropriate order program limitations 255 and shipment optimizations 260 as compared to the provided preliminary order information 280 to determine a compliance state of the information 280. Order compliance feedback (a type of messaging data 275) may be generated by portal interface logic 245 as a notification on the interface to the buying client device 120a.

In more detail, the generated order compliance notification, as part of this feedback to buying client device 120a, may provide an electronically formatted updated compliance status related to the pre-submission order adherence of the preliminary order when the front-end server receives an update to the previously provided preliminary order information 280. For example, in some embodiments, the preliminary order information 280 may be serially entered in parts (e.g., with prompted entry of desired quantities of particular products available to be purchased according with the order program limitations 255 that correspond to the authorized user). As the different parts of the preliminary order information 280 are provided or “entered” for consideration by order compliance program module 240, the compliance status notification may be continually and automatically regenerated to reflect the most current state of the preliminary order information 280 as the authorized user builds the preliminary order of program goods. Such an automatic compliance status notification may be generated by portal interface logic 245 and order adherence logic 250 (based on assessing the currently entered preliminary order information 280 against certain order program limitations 255 and shipment compliance limitations 260) to text, symbols, or other graphics on the interface to summarizes the results of the pre-submission order adherence determination for the preliminary order.

If the preliminary order information 280 is determined to be in a compliant state, the order compliance program module 240 may transmit an order summary message (another type of messaging data 275) to the buying client device 120a. The order summary message 275 may have a formatted order (corresponding to the compliant preliminary order) generated in a format suitable for submission to order management system 110 so that system 110 improves its operation by being able to more quickly input and process the order without wasting valued effort on system 110. In another embodiment, when the preliminary order information 280 is determined to be in a compliant state, the order compliance program module 240 may transmit the compliant preliminary order information 280 (or a separate message that includes the compliant preliminary order information 280) directly to order management system 110 (such as an EDI submission of preliminary order information 280 directly to order management system 110).

While FIG. 3 illustrates the logical relationship between the different exemplary program modules and data during a pre-submission order adherence determination in an embodiment, FIGS. 4A-4F are a series of exemplary screenshots of a user interface displayed on an exemplary customer's client device (such as buying client device 120a) when interacting with the exemplary front-end server 105 as part of determining pre-submission order adherence for preliminary order that may later be submitted when compliant to order management system 110. Referring now to FIG. 4A, an exemplary interface 400 is shown as it may appear on a display of a client device (such as buying client device 120a) in an embodiment. The interface 400 may be a portal interface generated based upon layout and content information (e.g., hypertext markup language (HTML) and its related content, Adobe Flash applications, applets written in bytecode such as the Java programming language, and the like) served up by front-end server 105 to a browser application resident and executing on the client device. In this manner, the front-end server 105 is considered to generate the portal interface for the client device by providing relevant data, information, code and content representing the portal interface content (as shown within interface 400 on FIG. 4A) once the user of the client devices establishes a connection with the front-end server 105 (e.g., via a uniform resource identifier (URL) for a web page hosted by front-end server 105).

As shown on FIG. 4A, interface 400 presents a login entry section (405, 410) where the user provides secure login information about the user operating the client device. Such login information may include an email address for the user provided in a first part of the login entry section 405, and a password for the user provided in a second part of the login entry section 410. As such, the front-end server 105 may identify the user from the secure login information as a registered user authorized to access further functionality to be presented on the interface 400. For example, the secure login information may be received by order adherence logic 250 (via information pass through portal interface logic 245) where front-end server 105 may then verify the registered or authorized status of the user providing the login information with reference to authorized user data 265 maintained, for example, in database 230 or other memory on front-end server 105. Those skilled in the art will appreciate that the authorized user will have initially interacted with the front-end server 105 to become an authorized or registered user (e.g., a registered online customer, registered distributor, or registered distributor's authorized customer) via a registration process that gathers relevant user information (e.g., name, business organization, role within the business organization, contact information for the user, desired services to use on the front-end server 105, and security related information, such as a password and security questions that may be used when logging into the front-end server 105).

Once the user of the client device has successfully logged in via the secure login information provided, interface 400 may present further interactive content (e.g., images, text, menus, buttons, and the like) as shown in FIG. 4B. Referring now to FIG. 4B, the authorized user is presented with, for example, an Orders & Pricing menu tab 415 and menu selection 420 labeled “Co-Mingle Load Builder.” Interactively selecting this menu selection 420 has the authorized user indicating a desire to create or build a preliminary order of program goods that may be advantageously assessed for order adherence by front-end server 105.

After selecting menu selection 420, FIG. 4C illustrates how interface 400 may then present information relevant to the particular authorized user. For example, prior order information previously provided by the authorized user may be presented as a past request 440 in a request section 425 of the interface 400 in an embodiment. The authorized user may select the past request 440 to use as current preliminary order information to be presently assessed for order adherence by front-end server 105 (or as a starting point for the preliminary order information, with as shown in FIG. 4D may be further revised or edited). However, if the authorized user does not have any past requests or desires to start a new request related to a preliminary order of program goods, the authorized user may select a “New Request” button shown on interface 400. Doing so will have the interface 400 bring up a banner 435 prompting the authorized user for relevant information about the new request, such as a request name and whether the authorized user would like the program goods selected to be part of this particular new preliminary order in a particular shipping format (e.g., a pallet preference for arranging the program goods in shipment configurations).

As shown in FIG. 4D, interface 400 then provides the authorized user with a selection entry interface portion 445, which presents potential program goods for ordering as part of the preliminary order. The selection of such potential program goods may be according to order program limitations 255 associated with the identified authorized user. Such order program limitations 255 may include a set of authorized program goods for selection by the identified authorized user. As noted above, such authorized goods may be a subset of potential goods available for purchase online in some embodiments or may be include all such potential goods in other embodiments. Thus, depending on the particular purchasing program associated with the authorized user, front-end server 105, via order compliance program module 240, populates the selection entry interface portion 445 with different program goods on corresponding entry fields. Accordingly, the authorized user is able to enter selection information for the preliminary order, such as an entered quantity 450 in an entry field corresponding to a particular program good shown in interface portion 445. As selection information is provided in entries of interface portion 445 is this particular embodiment, a request summary interface portion 455 is updated to indicate just the product and related quantity added as part of the preliminary order (as opposed to listing out all potential program goods available as shown in the selection entry interface portion 445).

In general, as the authorized user provides the preliminary order information via the selection entry interface portion 445, the order adherence logic 250 compares the provided preliminary order information with one or more order program limitations 255 for the authorized user and shipment compliance limitation 260 to determine pre-submission order adherence of the preliminary order in its current state. From the perspective of the authorized user, as the preliminary order information is entered via the selection entry interface portion 445, several parts of interface 400 advantageously provide the results from this comparison as pre-submission order compliance feedback.

In the illustrated embodiment shown in FIG. 4D, several compliance notification portions 460 and 470 of interface 400 show different types of order compliance feedback as a result of determining the pre-submission order adherence of the preliminary order. For example, the “Product Request Summary” compliance notification portion 460 provides a notification in the form of a summarized result of the comparison of the current state of the received information on the preliminary order to the order program limitations. Notification portion 460, as shown, indicates an overall compliance status, such as “Request Status: Adheres” as indicated at point 465 of notification portion 460. Notification portion 460 may further provide summarized status information related to particular order program limitation details, such as the state of the received preliminary order information shown in the selection entry interface portion 445 and the request summary interface portion 455 as compared to an order volume restriction and an order weight restriction. For example, notification portion 460 as shown in the example of FIG. 4D indicates exemplary summarized status information on order program limitations to include gross weight information for the current preliminary order, a number of copy/paper pallets in the current preliminary order, a number of total floor spots taken up by the program goods in the current preliminary order, and the number of cases/cartons (CS/CTN) that make up the program goods in the current preliminary order. In some embodiments, notification portion 460 may reflect summarized status information where the order program limitations are a balanced combination of different types of order program limitations. Thus, notification portion 460 provides a type of summarized result with both an overall indication of compliance status as well as summarized status information on particular kinds of order program limitations.

Notification portion 470 provides order compliance related feedback in a graphic summary form that notifies the authorized user operating the client device about how the current preliminary order compares to shipment compliance limitations 260, such as a percentage occupied status for a transport container. Such shipment compliance limitations 260 may vary per business organization's purchasing program, or vary per authorized user. The graphic summary form for the order compliance feedback in notification portion 470 may be relative to certain desired thresholds. For example, as shown in FIG. 4D, the current status of the preliminary order information corresponds to a shipment load status that meets 100% of the total floor spots for a given transport container used to ship the ordered program goods (e.g., a tractor trailer, an intermodal shipping container, and a delivery vehicle having a storage compartment corresponding to the shipment capacity). While this graphic order adherence status indicator shows a graphic comparison based on a desired occupancy threshold, other graphic order adherence status indicators may show a comparison based on a desired threshold for certain products (e.g., the number of copy paper pallets being ordered relative to limitations on a maximum or minimum for the preliminary order).

As shown in FIG. 4D, the pre-submission order adherence status of the preliminary order may be continually updated as shown on interface 400 as the authorized user either enters additional product selections in the selection entry interface portion 445 or revises already entered selection information (e.g., desired quantities) using the request summary interface portion 455. In this manner, the authorized user is advantageously presented with compliance feedback prior to order submission and, in some cases, as the preliminary order is being “built” to enhance the interactive refinement of the preliminary order as it becomes compliant relative to the order program and shipment compliance limitations.

Once all information and selections for the preliminary order information are completely entered, revisions are complete for a particular preliminary order, and the order compliance feedback indicates the preliminary order is adherent, the authorized user may then select a “Next” button 475 on the summary notification portion 460 of interface 400, as shown in FIG. 4E. Selecting the “Next” button 475 allows the authorized user to add reference information for this particular preliminary order (e.g., further information to store as preliminary order information 280) as built via the interactions with front-end server 105 through the order compliance program module 240 and the client device. With the reference information added by the authorized user, selection of a “Submit” button 480 signifies the authorized user desires to then submit the preliminary order. In one embodiment, as shown in FIG. 4F, the front-end server 105 responds to selection of the “Submit” button 480 (as shown in FIG. 4E) and generates a formatted order 490 based on the current and compliant preliminary order information where the formatted order 490 is acceptable for convenient receipt by order management system 110. The front-end server 105 then transmits an order summary message (such as an email message) with the formatted order 490 to the authorized user's client device. As such, the authorized user's client device may review the formatted order 490 with a viewing program, such as Adobe Reader. The authorized client may then have the formatted order 490 submitted to order management system 110 with the assistance of customer service personnel operating customer service server system 115 (via customer service client device 130). In other embodiments, the formatted order 490 may be transmitted directly to the customer service server system 115, which then forwards the pre-submission compliant order to order management system 110. In still other embodiments, the front-end server 105 may transmit the formatted order 490 directly to the order management system 110 in the networked system 100 when the order compliance feedback indicates a compliance state for the preliminary order and the authorized user selects the “Submit” button 480.

FIG. 5 is a flow diagram illustrating exemplary steps for an improved method for assessing order compliance by determining pre-submission order adherence of a preliminary order of program goods using a front-end server (such as front-end pre-processing server 105 shown in FIGS. 1 and 2) coupled to an order management apparatus (such as order management system 110 shown in FIG. 1) as elements of a networked system in accordance with an embodiment of the invention. Referring now to FIG. 5, the algorithmic steps that implement method 500 begin at step 505 with the front-end server of the system generating a portal interface for a client device in communication with the front-end server apparatus. For example, as shown in FIGS. 4A-4F, front-end server 105 has portal interface logic 245 generate interface 400 when in communication with one of the buying client devices 120a-120c via a browsing application running on the respective client device. While interface 400 comprises a webpage interface shown within the browsing application on the client device, those skilled in the art will appreciate that other embodiments may generate a portal interface using a dedicated client/server interface hosting paradigm where the portal interface generated and hosted by the server for the client device allows for an external system outside of the front-end server (i.e., the client device) to host a client-side portal interface portion to establish the requisite connection from the client device to the front-end server.

At step 510, method 500 continues with the front-end server receiving secure login information from the client device, where the secure login information identifies an authorized user. For example, an embodiment may have a user of a client device provide secure login information in the exemplary form of an email address and password, such as that shown on FIG. 4A where such secure login information may be entered using the login entry sections 405 and 410. The provided login information, in this example, may be received by the order compliance program module 240, which then compares the received login information to registered user data 265 maintained and accessible to the processor 200 of front-end server 105. In this way, the comparison may indicate if the secure login information is valid and verifies that the user of the client device is an authorized user.

At step 515, method 500 continues with the front-end server accessing order program limitations maintained in a memory of the front-end server based upon at least a portion of the secure login information identifying the authorized user. As previously explained, each authorized user has corresponding order program limitations 255 associated with them and/or their business organization they represent. In more detail, the order program limitations associated with the authorized user may generally be considered order parameter thresholds that, for example, may identify a combination of an order volume and an order weight as a threshold limitation against which preliminary order information should be measured. Exemplary order program limitations may include a minimum or maximum quantity of program goods in the preliminary order, a limit on the physical volume or floor space corresponding to program goods in the preliminary order, a gross weight limit for such goods in the preliminary order, and the like.

At step 520, method 500 continues with the front-end server generating a selective entry interface portion on the portal interface for information on the preliminary order. The selective entry interface portion is generated to be populated with program goods consistent with the order program limitations associated with the authorized user. For example, in an embodiment, as part of the order program limitations for the authorized user may identify particular program goods for potential purchase by the authorized user. Such order program limitations then limit what goods are shown in the selective entry interface potion generated on the portal interface. For example, as shown in FIG. 4D, interface 400 provides the authorized user with a selection entry interface portion 445, which presents potential program goods for ordering as part of the preliminary order as identified by the set of authorized program goods for selection in order program limitations 255 for the authorized user.

Once the selective entry interface portion is generated in step 520, method 500 continues to step 525 where the front-end server receives the information on the preliminary order from the client device via the selective entry interface portion. For example, as shown in FIG. 4D, the information on the preliminary order from the client device may be entered via selection entry interface portion 445 with particular quantities of desired particular goods from the set of authorized program goods available to the authorized user.

At step 530, method 500 continues with the front-end server comparing the received information on the preliminary order to the order program limitations associated with the authorized user as well as to a shipment compliance limitation maintained in the memory of the front-end server (such as shipment compliance limitation 260) as part of determining the pre-submission order adherence of the preliminary order. In more detail, the shipment compliance limitation may comprise, for example, a shipment load compliance characteristic associated with a transport container (such as a tractor trailer, an intermodal shipping container, and a delivery vehicle having a storage compartment). Such a shipment load compliance characteristic associated with the transport container may, in some embodiments, comprise a desired percentage occupied threshold for the transport container. For example, the shipment load compliance characteristic used in a shipment compliance limitation may identify a minimum percentage full characteristic relative to the particular transport container. In other examples, the shipment load compliance characteristic used in a shipment compliance limitation may identify an acceptable range for the percentage full characteristic relative to the particular transport container (such as between 95% to 100% full).

Depending on the implementation, the shipment compliance limitation may be system-wide and common for all customers. However in other embodiments, the shipment compliance limitation may be specialized per authorized user, or specialized according to the particular business organization related to the authorized user. For example, particular users may have program goods shipped in a manner that requires particular types of transport containers or a given business organization may only desire handling of particular types of transport containers. Thus, having the ability to adaptively apply the shipment compliance limitation on a more selective basis provides further offloading of conventional order processing burdening later by an order management system, such as system 110.

At step 535, method 500 continues with the front-end server providing order compliance feedback to the client device over the portal interface. The order compliance feedback provides the results of determining the pre-submission order adherence of the preliminary order. Such results from the front-end server may take the form, for example, of a notification generated by the front-end server on a portion of the portal interface. This may occur when the preliminary order information has been submitted, received, and compared. This may also occur when the notification provides an updated compliance status related to the pre-submission order adherence of the preliminary order when the front-end server receives an update to the information on the preliminary order.

The generated notification on the portion of the portal interface may be a summarized result of the comparison of the received information on the preliminary order to the order program limitations (such as the compliance notification portion 460 shown in FIG. 4D), a graphically summarized status corresponding to a percentage occupied threshold for a transport container (such as the compliance notification portion 470 shown in FIG. 4D), or a notification having both summarized textual results and graphically or symbolically represented results.

At step 540, method 500 proceeds back to step 530 for a further comparison to update the pre-submission order adherence determination when the front-end server received more preliminary order information, but otherwise proceeds to step 545. This may take the form of new quantities of other types of program goods to add to the preliminary order information already submitted to the front-end server by the client device. Alternatively, this may take the form of altered quantities (including deleting all quantities) of existing types of program goods in the preliminary order information. Thus, the algorithmic operation of steps 530-540 allows for receiving updates and providing quick and advantageous order compliance feedback that helps improve the overall electronic procurement system operation.

At step 545, method 500 proceeds to step 550 if the comparison of step 530 results in a determination that the preliminary order is in a compliance state (i.e., the preliminary order is adherent to the order program and shipment limitations for the authorized user). Otherwise, the preliminary order remains in a non-adherent state (as indicated by the order compliance feedback of step 535) and further preliminary order information is required (e.g., further items to order or changing of items already in the order), which has method 500 proceeding from step 545 back to step 540.

At step 550, method 500 has the front-end server transmitting the compliant preliminary order to an order management system (such as system 110 shown and explained relative to FIG. 1) based upon input from the client device (such as selection of a “Submit” button 480 shown in FIG. 4F). The transmission of the compliant preliminary order in step 550 may take several forms in various embodiments. For example, in a further embodiment of method 500, step 550 may have the front-end server transmit a formatted order directly to the order management apparatus in the networked system when (a) the order compliance feedback indicates the preliminary order is in a compliance state (such as an indication that the preliminary order information submitted thus far successfully meets the order program limitations and the shipment compliance limitations) and (b) in response to receiving an order submission input from the client device over the portal interface. Such a formatted order for the preliminary order information may, for example, be submitted directly to the order management system as an EDI formatted order correspondingly suited for processing by the order management apparatus in the networked system.

The compliant preliminary order may be transmitted in step 550 in an indirect manner to the order management system. Thus, in another embodiment of method 500, step 550 may have the front-end server transmit an order summary message to the client device when (a) the order compliance feedback indicates a compliance state for the preliminary order and (b) in response to receiving an order submission input from the client device over the portal interface. Here, the order summary message includes a formatted order (corresponding to the compliant preliminary order) suitable for submission to the order management apparatus. For example, the order summary message (including formatted order 490) may be transmitted as messaging data 275 by the order compliance program module 240 running on front-end server 105 to the client device (such as buying client device 120a). The authorized user may then send the formatted order 490 to order management system 100 via customer service server system 115 and assisted by customer service personnel operating customer service client device 130. In still another embodiment of method 500, step 550 may have the front-end server transmit the order summary message to the customer service server system 115 for intermediate review of the formatted order, or for just forwarding to order management system 100.

Those skilled in the art will appreciate that aspects of method 500 as disclosed and explained above in various embodiments may be implemented on a front-end server apparatus (such as front-end pre-processing server 105 alone or as part of networked 100 illustrated in FIG. 1) and running one or more parts of order compliance program module 240 to implement any of the above described functionality. Such parts of the program module may be stored on a non-transitory computer-readable medium (such as memory storage 215 or 230 in the exemplary front-end server 105). Thus, when executing such code, a processing unit of the front-end server (such as unit 200) may be operative to perform operations or steps from the exemplary methods disclosed above, including method 500 and variations of that method.

From a system perspective (as generally explained with reference to FIG. 1) and building upon the above-described functionality involving the determination of pre-submission order adherence of a preliminary order with reference to FIG. 5, a further embodiment may include a pre-submission order adherence system for a preliminary order of program goods. In general, such an exemplary pre-submission order adherence system may comprise a front-end server, an order management system, and a customer service server. The front-end server (such as exemplary front-end server 105) comprises a network communication interface (such as network interface 210) and a memory storage (such as memories 215, 220 and/or database 230). The network communication interface in the front-end server provides interactive data access to a customer client device (related to customer service personnel involved in sales of the program goods) over a data communication network. The memory storage in the front-end server maintains an order compliance program module comprising at least a portal logic portion (such as portal interface code 245) operative to generate a portal interface for the customer client device over the network communication interface, and an order adherence logic portion (such as order adherence code 250) operative to selectively provide user specific order program limitations and a shipment compliance limitation.

The order management system is disposed as an element of this system embodiment in communication with the front-end server over the network communication interface of the front-end server. The order management system is operative to accept an order for the program goods and manage fulfillment operations related to the accepted order. The customer service server is disposed as another part of the system embodiment in communication with the front-end server over the network communication interface of the front-end server and deployed in further communication with the order management system (such as shown in FIG. 1 with system 115 in communication with order management system 110).

The front-end server in this system embodiment, when executing the order compliance program module, is specially adapted beyond that of a conventional computer to perform unconventional functions that, as a whole, are unconventional and advantageously facilitate a particular type of pre-submission order adherence determination. In more detail, in this system embodiment, the front-end server is operative to generate, using the portal logic portion, the portal interface (such as interface 400 shown in FIGS. 4A-4F) in response to a request from the customer client device and receive secure login information from the customer client device that identifies a registered user. Based upon the identified registered user (such as a user identified from comparing the received login information and authorized user data 265), the front-end server is further operative use the order adherence logic to identify the user specific order program limitations and the shipment compliance limitation based upon the identified registered user and generate an entry prompt via the portal interface. The entry prompt (such as a selective entry interface field, like the entered quantity field 450 shown in FIG. 4D) requests information on the preliminary order. Upon receiving information on the preliminary order, the front-end server in this system embodiment is then operative to determine the pre-submission order adherence of the preliminary order by comparing the received information on the preliminary order to the identified user specific order program limitations and to the shipment compliance limitation. The front-end server then generates order compliance feedback for display within a portion of the portal interface. Such order compliance feedback provides a notification of the results of determining the pre-submission order adherence of the preliminary order.

When the order compliance feedback indicates a compliance state for the preliminary order (such as that indicated on notification portions of interface 400) and the front-end server receives an order submission input from the customer client device over the portal interface (such after the authorized user selects a “Submit” button 480 as shown on FIG. 4E), the front-end server in the system is operative to transmit an order summary message to the customer client device and/or the customer service server. Such an order summary message includes a formatted order associated with the preliminary order in a format suitable for submission to the order management system in the system embodiment.

Additionally, the customer service server in this system embodiment is further operative to receive the order summary message notifying the customer service server about the compliance state for the preliminary order, and provide the formatted order to the order management system as the order for the program goods without burdening the order management system with pre-submission order adherence operations.

In a further system embodiment, the front-end server of the system may transmit the formatted order directly to the order management system in the networked system in response to receiving the order submission input from the customer client device over the portal interface and when the order submission input reflects an authorized direct submission path for the formatted order. Thus, in this further embodiment, the order compliance program module may allow for the authorized user to select how the compliant preliminary may be submitted—e.g., direct to the order management system, indirect with the formatted order sent to the client device for later transmission to the order management system, or indirect with the formatted order sent to the customer service server for forwarding or later transmission to the order management system with or without further refinement of the compliant preliminary order (which offloads order compliance tasking from the order managements system and the customer service server).

FIGS. 6A and 6B are collectively another flow diagram illustrating exemplary steps of another improved method for assessing order compliance by determining pre-submission order adherence of a preliminary order of select program goods using a front-end server coupled to an order management apparatus in a networked system in accordance with an embodiment of the invention. The embodiments described with respect to FIG. 6 provide further detail and generally focus on generating particular user interface aspects when determining pre-submission order adherence of such a preliminary order, and further build upon the method embodiments described above with respect to FIG. 5 and may be equally applicable on a system-level embodiment similar to that described above.

Referring now to FIG. 6A, exemplary method 600 begins at step 605 with the front-end server executing a portal interface code module (such as portal interface code module 245) to generate a portal interface (such as interface 400) for a client device in communication with the front-end server. In this way, the portal interface may be generated in one embodiment with the front-end server 105 webpage hosting via execution of the portal interface code 245. At step 610, method 600 proceeds with execution the portal interface code that has the front-end server receiving secure login information from the client device via the generated portal interface. Such secure login information includes sufficient information, such as user ID or an email, which identifies the user as an authorized user when compared against the authorized or registered user data 265.

At step 615, method 600 has the front-end server executing at least an order adherence code module (such as order adherence code 250 of the order compliance program module 240) to access a subset of order program limitations maintained on a memory storage of the front-end server. The subset of order program limitations accessed is those associated with the identified authorized user. In one embodiment, the accessed subset of order program limitations includes (a) a set of authorized program goods for selection by the identified authorized user, and (b) a combination of one or more order volume restrictions and one or more order weight restrictions. In other embodiments, the set of authorized program goods may be maintained separately from the order program limitations (such as maintaining product data 270 separate from order program limitations (a type of program data 255)), but the appropriate set of authorized program goods may still be identifiable according to the identity of the authorized user or the user's business organization.

In more detail, a further embodiment of method 600 may have the order volume restriction comprising at least one of a quantity threshold related to those from the set of authorized program goods selected by the authorized user via the client device (e.g., a maximum or minimum quantity parameter or threshold), and/or a physical space threshold corresponding to those from the set of authorized program goods selected by the authorized user via the client device (e.g., a minimum number of total pallets that occupy a given space). Additionally, another embodiment of method 600 may have the order weight restriction comprises a gross weight restriction corresponding to those from the set of authorized program goods selected by the authorized user via the client device.

At step 620, method 600 has the front-end server executing at least the executing the portal interface code to generate a selection entry interface portion within the portal interface. The selection entry interface portion comprises a plurality of entries corresponding to the set of authorized program goods that may be selected for order by the authorized user.

At step 625, method 600 has the front-end server executing at least the executing the portal interface code to receive an initial selection from the client device of one or more of the entries from the selection entry interface portion of the portal interface. In the embodiment illustrated in FIG. 4D, quantity information may be submitted by the authorized user in a quantity field 450 of the selection entry interface portion 445. For example, the authorized user may provide a quantity of 700 in quantity field 450, which then operates to be received as received information on the preliminary order. If quantities of other products shown in selection entry interface portion 445 are entered, such information is added to the total received information on the preliminary order and assessed accordingly as explained in more detail below.

At step 630, method 600 has the front-end server executing at least the order adherence code module to compare the received information on the preliminary order to the subset of order program limitations associated with the identified user as well as to a shipment compliance limitation as part of determining the pre-submission order adherence of the preliminary order. In more detail, the shipment compliance limitation may be implemented as a shipment load occupation percentage threshold relative to a shipment capacity of a transport container (such as a tractor trailer, an intermodal shipping container, and a delivery vehicle having a storage compartment corresponding to the shipment capacity). In another example, the shipment compliance limitation may comprise at least one shipment load characteristic restriction related to the authorized user. In still another example, the shipment load characteristic restriction may comprise a business organization level shipment load characteristic restriction related to the authorized user. After step 630, method 600 transitions through point A to step 635 on FIG. 6B.

Referring now to step 635 on FIG. 6B, method 600 proceeds with the front-end server executing at least the portal interface code to generate or update a compliance notification portion within the portal interface. The compliance notification portion (such as notification portions 460 and 470 as shown on FIG. 4D) provides at least initial order compliance feedback to the client device. Such initial order compliance feedback provides the results of determining the pre-submission order adherence of the preliminary order as performed in step 630. In a further embodiment, the compliance notification portion may be implemented as a summarized result of the comparison of the current state of the received information on the preliminary order to the subset of order program limitations. Such a summarized result may include textually displayed summary information reflecting the current state of the preliminary order information and an overall adherence indicator (such as that shown in FIG. 4D with notification portion 460). In another embodiment, the compliance notification portion may be implemented as a graphically summarized status notifying the authorized user operating the client device about a percentage occupied status for a transport container, such as a bar graph that symbolically changes shape to indicate the summarized status (such as that shown in FIG. 4D with notification portion 470).

In even more detail, an embodiment may generate or update the compliance notification portion within the portal interface to have a first summary notification area and a second summary notification area. The first summary notification area may present an updated summarized result of the comparison of the current state of the current state of the received information on the preliminary order to the subset of order program limitations after the front-end server received the updated selection from the client device. In similar fashion, the second summary notification portion may present a graphically summarized status notifying the authorized user operating the client device about a percentage occupied status for a transport container according to the shipment compliance limitation after the front-end server received the updated selection from the client device.

After generating or updating the compliance notification portion within the portal interface at step 635, method 600 proceeds to step 640. At step 640, if the front-end server receives an updated selection from the client device of one or more of the entries from the selection entry interface portion (reflecting an updated current state of the received information on the preliminary order), method 600 proceeds from step 640 to step 645. At step 645, method 600 proceeds with the front-end server revising the determination of the pre-submission order adherence of the preliminary order based on an updated comparison of the current state of the received information on the preliminary order (after receiving the updated selection(s) in step 640) to the subset of order program limitations and to the shipment compliance limitation. Thus, as the authorized user adds further quantities of desired goods from the available program goods shown in the selective entry interface portion, the compliance notification portion is updated.

However, if at step 640, no further selections are received, step 640 has method 600 proceeding to step 650. At step 650, method 600 proceeds to step 655 if the compliance notification portion reflects the preliminary order as it stands is in a compliance state. If not, step 650 returns to step 640 awaiting receipt of updated selection(s) as preliminary order information.

At step 655, the front-end server has determined the preliminary order is in the compliance state and the compliance state is reflected as such in the compliance notification portion of the portal interface. This allows the authorized user to provide input on whether to submit the compliant preliminary order. For example, an embodiment may have the authorized user select a “Submit” button 480 as shown on FIG. 4E. In that case, step 655 proceeds to step 660. Otherwise, the authorized user may still have further information and selections to add to the preliminary order and step 655 proceeds back to step 640.

At step 660, method 600 proceeds with the front-end server executing the order adherence code to generate a formatted order from the information on the preliminary order where the formatted order has a format acceptable to the order management system.

At step 665, method 600 may proceed with the front-end server transmitting the formatted order presenting the compliant preliminary order to the order management system. In one further embodiment, step 665 may have the front-end server transmit the formatted order directly to the order management apparatus in the networked system in response to receiving order submission input from the client device over the portal interface (such as when the authorized user selects the “Submit” button 480). Such a formatted order for the preliminary order information may, for example, be submitted directly to the order management apparatus as an EDI formatted order correspondingly parsed into a standard order processing format for processing by the order management apparatus in the networked system.

The compliant preliminary order may be transmitted in step 665 in an indirect manner to the order management apparatus. Thus, in another embodiment of method 600, step 665 may have the front-end server transmit an order summary message to the client device in response to receiving an order submission input from the client device over the portal interface, where the order summary message includes the formatted order suitable for submission to the order management apparatus. The authorized user may then send the formatted order (such as order 490 displayed in FIG. 4F) to the order management apparatus via a customer service server system (such as system 115) and assisted by customer service personnel operating customer service client device (such as device 130). In still another embodiment of method 600, step 665 may have the front-end server transmit the order summary message to the customer service server system so that the customer service server system will forward the formatted order to the order management apparatus.

Those skilled in the art will appreciate that aspects of method 600 as disclosed and explained above in various embodiments may be implemented on a front-end server apparatus (such as front-end pre-processing server 105 alone or as part of networked 100 illustrated in FIG. 1) and running one or more parts of order compliance program module 240, such as portal interface code 245 and order adherence code 250, to implement any of the above described functionality. Such parts of the program module and data generated during operation (such as the preliminary order information 280 and/or messaging data 275) may be stored on a non-transitory computer-readable medium (such as memory storage 215 or 230 in the exemplary front-end server 105). When executing such code, a processing unit of the front-end server (such as unit 200) may be operative to perform operations or steps from the exemplary methods disclosed above, including method 600 and variations of that method.

Further still, yet another system embodiment may be deployed that comprises the front-end server as described with respect to method 600 and its variations above, along with an order management apparatus (such as system 110) and a customer service server (such as system 115). This additional system embodiment, thus, builds upon the description above relative to method 600 with the front-end server being one of the elements and similar interactions with order management apparatus and the customer service server as described above with the system embodiment that leverages and builds on the functionality as described relative to method 500.

In summary, it should be emphasized that the sequence of operations to perform any of the methods and variations of the methods described in the embodiments herein are merely exemplary, and that a variety of sequences of operations may be followed while still being true and in accordance with the principles of the present invention.

Those skilled in the art will appreciate that embodiments may provide one or more advantages, and not all embodiments necessarily provide all or more than one particular advantage as set forth here. Additionally, it will be apparent to those skilled in the art that various modifications and variations can be made to the structures and methodologies described herein. Thus, it should be understood that the invention is not limited to the subject matter discussed in the description. Rather, the present invention, as recited in the claims below, is intended to cover modifications and variations.

What is claimed:

1. An improved front-end server implemented method for assessing order compliance by determining pre-submission order adherence of a preliminary order of program goods using the front-end server coupled to an order management apparatus in a networked system, the method comprising:
generating, by the front-end server, a portal interface for a client device in communication with the front-end server;
receiving, by the front-end server, secure login information from the client device, the secure login information identifying an authorized user;
accessing order program limitations maintained in a memory of the front-end server based upon at least a portion of the secure login information identifying the authorized user, the accessed order program limitations being associated with the authorized user;
generating, by the front-end server, a selective entry interface portion on the portal interface for information on the preliminary order, wherein the selective entry interface portion is populated with program goods consistent with the order program limitations associated with the authorized user;
receiving, by the front-end server, the information on the preliminary order from the client device via the selective entry interface portion;
comparing, by the front-end server, the received information on the preliminary order to the order program limitations associated with the authorized user and to a shipment compliance limitation maintained in the memory of the front-end server as part of determining the pre-submission order adherence of the preliminary order; and
providing order compliance feedback, by the front-end server, to the client device over the portal interface, the order compliance feedback providing the results of determining the pre-submission order adherence of the preliminary order.

2. The method of claim 1 further comprising the step of transmitting, by the front-end server, an order summary message to the client device when (a) the order compliance feedback indicates the preliminary order is in a compliance state and (b) in response to receiving an order submission input from the client device over the portal interface, the order summary message comprising a formatted order suitable for submission to the order management apparatus.

3. The method of claim 2, wherein the compliance state for the preliminary order indicates the received information on the preliminary order successfully meets the order program limitations and the shipment compliance limitation.

4. The method of claim 1 further comprising the step of transmitting, by the front-end server, a formatted order directly to the order management apparatus in the networked system when (a) the order compliance feedback indicates a compliance state for the preliminary order and (b) in response to receiving an order submission input from the client device over the portal interface.

5. The method of claim 4, wherein the compliance state for the preliminary order indicates the received information on the preliminary order successfully meets the order program limitations and the shipment compliance limitation.

6. The method of claim 4, wherein the formatted order comprises an EDI formatted order correspondingly suited for processing by the order management apparatus in the networked system.

7. The method of claim 1, wherein the order program limitations associated with the authorized user comprise a combination of an order volume and an order weight.

8. The method of claim 7, wherein the order volume comprises at least one of a quantity of the program goods as identified by the information on the preliminary order and a physical space corresponding to the program goods as identified by the information on the preliminary order.

9. The method of claim 7, wherein the order weight comprises a gross weight restriction corresponding to the program goods as identified by the information on the preliminary order.

10. The method of claim 1, wherein the shipment compliance limitation comprises a shipment load compliance characteristic associated with a transport container.

11. The method of claim 10, wherein the shipment load compliance characteristic associated with the transport container comprises a desired percentage occupied threshold for the transport container.

12. The method of claim 1, wherein the order compliance feedback comprises a notification generated by the front-end server on a portion of the portal interface, the notification providing an updated compliance status related to the pre-submission order adherence of the preliminary order when the front-end server receives an update to the information on the preliminary order.

13. The method of claim 12, wherein the generated notification comprises a summarized result of the comparison of the received information on the preliminary order to the order program limitations.

14. The method of claim 12, wherein the generated notification comprises a graphically summarized status corresponding to a percentage occupied threshold for a transport container.

15. A pre-submission order adherence system for a preliminary order of program goods, the system comprising:
a front-end server further comprising
a network communication interface providing access to a customer client device over a data communication network,
a memory storage that maintains an order compliance program module comprising at least
a portal logic portion operative to generate a portal interface for the customer client device over the network communication interface, and
an order adherence logic portion operative to selectively provide user specific order program limitations and a shipment compliance limitation;
an order management system in communication with the front-end server over the network communication interface of the front-end server, the order management system being operative to accept an order for the program goods and manage fulfillment operations related to the order; and
a customer service server in communication with the front-end server over the network communication interface of the front-end server, the customer service server operative to communicate with the order management system; and
wherein the front-end server, when executing the order compliance program module, is operative to
generate, using the portal logic portion, the portal interface in response to a request from the customer client device,
receive secure login information from the customer client device, the secure login information identifying a registered user,
identify, using the order adherence logic, the user specific order program limitations and the shipment compliance limitation based upon the identified registered user, generate a prompt via the portal interface, the prompt requesting information on the preliminary order,
receive the information on the preliminary order,
determine the pre-submission order adherence of the preliminary order by comparing the received information on the preliminary order to the identified user specific order program limitations and to the shipment compliance limitation,
generate order compliance feedback for display within a portion of the portal interface, the order compliance feedback providing the results of determining the pre-submission order adherence of the preliminary order, and
transmit an order summary message to at least one of the customer client device and the customer service server when (a) the order compliance feedback indicates a compliance state for the preliminary order and (b) in response to receiving an order submission input from the customer client device over the portal interface, the order summary message comprising a formatted order associated with the preliminary order in a format suitable for submission to the order management apparatus; and
wherein the customer service server is further operative to receive the order summary message notifying the customer service server about the compliance state for the preliminary order, and provide the formatted order to the order management system as the order for the program goods without burdening the order management system with pre-submission order adherence operations.

16. The system of claim 15, wherein the compliance state for the preliminary order indicates the received information on the preliminary order successfully meets the order program limitations and the shipment compliance limitations.

17. The system of claim 15, wherein the front-end server of the system is further operative to transmit the formatted order directly to the order management system in the networked system in response to receiving the order submission input from the customer client device over the portal interface and when the order submission input reflects an authorized direct submission path for the formatted order.

18. The system of claim 17, wherein the compliance state for the preliminary order indicates received information on the preliminary order successfully meets the user specific order program limitations and the shipment compliance limitation based upon the identified registered user.

19. The system of claim 17, wherein the formatted order comprises an EDI formatted order correspondingly suited for processing by the order management apparatus in the networked system.

20. The system of claim 15, wherein the user specific order program limitations associated with the identified authorized user relate to a combination of an order volume and an order weight.

21. The system of claim 20, wherein the order volume comprises at least one of a quantity of the program goods as identified by the information on the preliminary order and a physical space corresponding to the program goods as identified by the information on the preliminary order.

22. The system of claim 20, wherein the order weight comprises a gross weight restriction corresponding to the program goods as identified by the information on the preliminary order.

23. The system of claim 15, wherein the shipment compliance limitation comprises a shipment load compliance characteristic associated with a transport container.

24. The system of claim 23, wherein the shipment load compliance characteristic associated with the transport container comprises a desired percentage occupied threshold for the transport container.

25. The system of claim 15, wherein the generated order compliance feedback comprises a notification generated by the front-end server within the portion of the portal interface, the notification providing an updated compliance status related to the pre-submission order adherence of the preliminary order when the front-end server receives an update to the information on the preliminary order.

26. The system of claim 15, wherein the generated order compliance feedback comprises a summarized result displayed in the portion of the portal interface, the displayed summarized result based upon comparing the received information on the preliminary order to the order program limitations from the order adherence record.

27. The system of claim 15, wherein the generated order compliance feedback comprises a graphically summarized status displayed in the portion of the portal interface, the graphically summarized status corresponding to a percentage occupied threshold for a transport container based upon the received information on the preliminary order.

28. An improved front-end server implemented method for assessing order compliance by determining pre-submission order adherence of a preliminary order of select program goods using the front-end server coupled to an order management apparatus in a networked system, the method comprising:
executing a portal interface code module, by the front-end server, to generate a portal interface for a client device in communication with the front-end server;
receiving, by the front-end server when executing the portal interface code, secure login information from the client device via the portal interface, the secure login information identifying an authorized user;
executing an order adherence code module, by the front-end server, to access a subset of order program limitations maintained on a memory storage of the front-end server, the subset of order program limitations being associated with the identified authorized user, the subset of order program limitations comprising (a) a set of authorized program goods for selection by the identified authorized user, and (b) a combination of an order volume restriction and an order weight restriction;
generating, by the front-end server when executing the portal interface code, a selection entry interface portion within the portal interface, the selection entry interface portion comprising a plurality of entries corresponding to the set of authorized program goods;
receiving, by the front-end server when executing the portal interface code, an initial selection from the client device of one or more of the entries from the selection entry interface portion of the portal interface, the initial selection corresponding to received information on the preliminary order;
comparing, by the front-end server when executing the order adherence code, the received information on the preliminary order to the subset of order program limitations associated with the identified user and to a shipment compliance limitation as part of determining the pre-submission order adherence of the preliminary order;
generating, by the front-end server when executing the portal interface code, a compliance notification portion within the portal interface, the compliance notification portion providing at least initial order compliance feedback to the client device, the initial order compliance feedback providing the results of determining the pre-submission order adherence of the preliminary order;
updating, by the front-end server when executing the portal interface code, the compliance notification portion within the portal interface to provide updated order compliance feedback to the client device as revised results of determining the pre-submission order adherence of the preliminary order as the front-end server
receives an updated selection from the client device of one or more of the entries from the selection entry interface portion, the updated selection reflecting a current state of the received information on the preliminary order, and
revises the determination of the pre-submission order adherence of the preliminary order based on an updated comparison of the current state of the received information on the preliminary order to the subset of order program limitations and to the shipment compliance limitation; and
generating, by the front-end server when executing the order adherence code, a formatted order from the information on the preliminary order when the updated order compliance feedback indicates a compliance state for the preliminary order, the formatted order having a format acceptable to the order management system that offloads the order management system from compliance processing.

29. The method of claim 28 further comprising the step of transmitting, by the front-end server, an order summary message to the client device in response to receiving an order submission input from the client device over the portal interface, the order summary message comprising the formatted order suitable for submission to the order management apparatus.

30. The method of claim 29, wherein the compliance state for the preliminary order indicates the current state of the received information on the preliminary order successfully meets the subset of the order program limitations and the shipment compliance limitation.

31. The method of claim 28 further comprising the step of transmitting, by the front-end server, the formatted order directly to the order management apparatus in the networked system in response to receiving an order submission input from the client device over the portal interface.

32. The method of claim 31, wherein the compliance state for the preliminary order indicates the current state of the received information on the preliminary order successfully meets the subset of the order program limitations and the shipment compliance limitation.

33. The method of claim 31, wherein the formatted order comprises an EDI formatted order correspondingly suited for processing by the order management apparatus in the networked system.

34. The method of claim 28, wherein the order volume restriction comprises at least one of a quantity threshold related to those from the set of authorized program goods selected by the authorized user via the client device, and a physical space threshold corresponding to those from the set of authorized program goods selected by the authorized user via the client device.

35. The method of claim 28, wherein the order weight restriction comprises a gross weight restriction corresponding to those from the set of authorized program goods selected by the authorized user via the client device.

36. The method of claim 28, wherein the shipment compliance limitation comprises a shipment load occupation percentage threshold relative to a shipment capacity of a transport container.

37. The method of claim 36, wherein the transport container comprises one from a group consisting of a tractor trailer, an intermodal shipping container, and a delivery vehicle having a storage compartment corresponding to the shipment capacity.

38. The method of claim 28, wherein the shipment compliance limitation comprises at least one shipment load characteristic restriction related to the authorized user.

39. The method of claim 38, wherein the at least one shipment load characteristic restriction comprises a business organization level shipment load characteristic restriction related to the authorized user.

40. The method of claim 28, wherein the compliance notification portion comprises a summarized result of the comparison of the current state of the received information on the preliminary order to the subset of order program limitations.

41. The method of claim 28, wherein the compliance notification portion comprises a graphically summarized status notifying the authorized user operating the client device about a percentage occupied status for a transport container.

42. The method of claim 28, wherein the compliance notification portion within the portal interface comprises:
a first summary notification area of the compliance notification portion, the first summary notification area presenting an updated summarized result of the comparison of the current state of the current state of the received information on the preliminary order to the subset of order program limitations after the front-end server received the updated selection from the client device; and
a second summary notification portion of the compliance notification portion, the second summary notification portion presenting a graphically summarized status notifying the authorized user operating the client device about a percentage occupied status for a transport container according to the shipment compliance limitation after the front-end server received the updated selection from the client device.
